(19) United States
(12) Patent Application Publication
(10) Pub. No.: US 2005/0175825 A1
(43) Pub. Date: Aug. 11, 2005

(54) Fibre reinforced heat element

(76) Inventors: Pal Francis Hansen, Fredrikstad (NO); Bjorn Pettersen, Krakeroy (NO)

Correspondence Address: YOUNG & THOMPSON, 745 SOUTH 23RD STREET, 2ND FLOOR, ARLINGTON, VA, 22202, US

(21) Appl. No.: 10/668,208

(22) Filed: Sep. 24, 2003

(30) Foreign Application Priority Data
Feb. 7, 2003 (NO) 2003.0643

(51) Int. Cl. B32B 3/00

(52) U.S. Cl. 428/209; 156/242

(57) ABSTRACT

The invention relates to a laminate, which is characterized in that it comprises at least one layer including a resistance element (1), and at least one layer formed of a fibre reinforced thermoplastic mat (2). The resistance element (1) and the thermoplastic layer (2) are laminated under pressure, preferably by vaccuum moulding, and the thermoplastic is melted under heat and then cooled so that the resistance element is completely or partly enclosed by thermoplastic and is consolidated as a laminate.

Further, a method is provided for manufacturing of a fibre reinforced laminated resistance element. In the method, at least one resistance element (1) is arranged together with at least one layer of a mat of reinforcement fibres (25) and thermoplastic fibres (26) in a mould, and the resistance elemetn (1) is moulded together with the fibre reinforced thermoplastic layer (2) under heat so that the thermoplastic fibres (26) melt and fill the fibre reinforcement (25), and under pressure, preferably by vaccuum moulding (28), so that they together form the fibre reinforced laminated resistance element.

This invention relates to a laminate and a method of manufacturing a fibre reinforced laminated resistance element.

### BACKGROUND OF THE INVENTION

Different types of heat elements exist on the market. In these elements, a pattern of resistive heating wires of metal is etched onto a carrier, which for example may be a polyvinyl chloride plastic (PVC). An adhesive for the resistive heating wires has often been applied to the carrier, e.g. glue which is burnt during use and emits harmful gases.

Such elements often have a low resistance for mechanical wear and tear and have a low capability of receiving bending moment which is exerted on the elements during use, so that they easily are broken. Thus, there is a need for heat elements which are sturdy and resistant to wear and tear.

### SHORT SUMMARY OF THE INVENTION

A laminate is provided which is characterized in that it comprises at least one layer including a resistance element, at least one layer formed of a fibre reinforced thermoplastic mat, and in which the resistance element and the fibre reinforced thermoplastic are laminated under pressure, preferably by vacuum moulding, and the thermoplastic is melted under heat and then cooled so that the resistance element completely or partly is enclosed by thermoplastic and further consolidated as a laminate.

Several embodiments and more advantages of the laminate according to the invention are indicated in the corresponding dependent apparatus claims.

Further, a method is developed for manufacturing a fibre reinforced laminated resistance element, in which the method comprises the following steps:
arranging at least one resistance element together with at least one layer of a mat of reinforcing fibres and thermoplastic fibres in a mould; and
moulding said resistance element together with said fibre reinforced thermoplastic layer under heat so as to melt the thermoplastic fibres and fill the fibre reinforcement, and under pressure, preferably by vaccuum moulding under a vaccuum bag, so as to together form the fibre reinforced laminated resistance element.

Further embodiments of the method according to the invention are indicated in the dependent method claims.

### SHORT DESCRIPTION OF THE DRAWINGS

FIG. 1 is a schematic view and a section of a laminate according to the invention, here shown with resistive wires arranged in a pattern in an area, and having electricity supply cables and a temperature sensor.

FIG. 2 is a schematic and exploded section of one embodiment of a laminate according to the invention, here shown before moulding and with the resistance element arranged between two fibre reinforced thermoplastic mats and on a base plate in the mould.

FIG. 3 is a schematic and exploded view of another embodiment of a laminate according to the invention, here shown before moulding with a vaccuum bag located on a resistance element arranged between two fibre reinforced thermoplastic mats, in which the base plate may form a part of the finished product.

FIG. 4 is a schematic and exploded view of an additional embodiment of a laminate according to the invention, wherein the resistance element is moulded together with a sandwich core between two layers of fibre reinforced thermoplastic.

The invention will now be described in more detail, with reference to the accompanying drawings.

### DETAILED DESCRIPTION OF PREFERRED EMBODIMENTS OF THE INVENTION

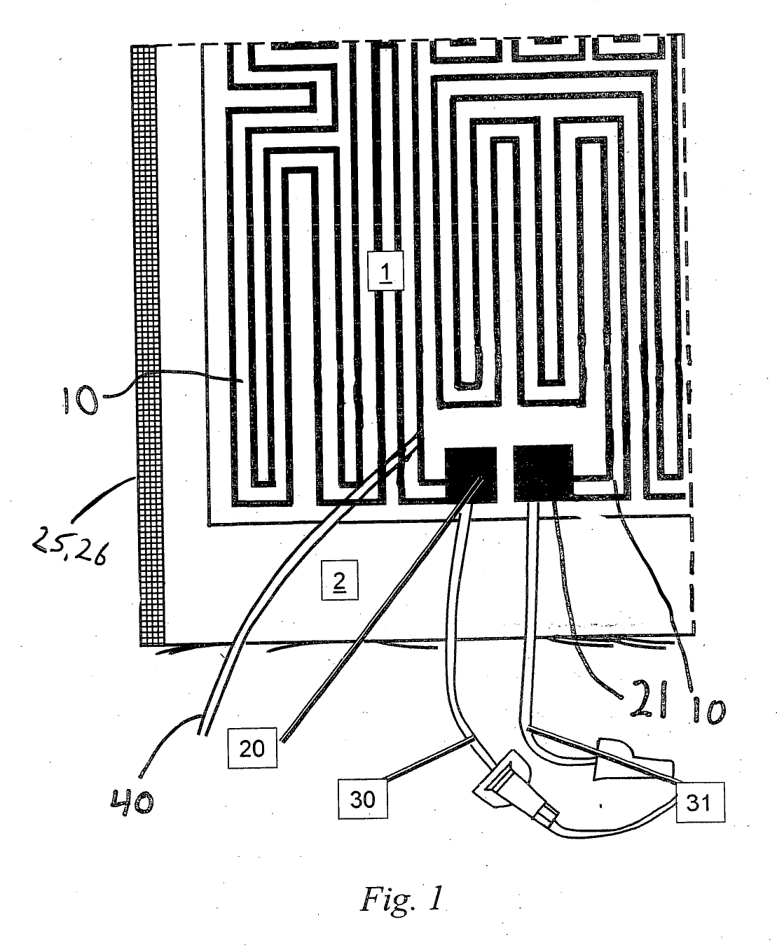

Reference is now made to FIG. 1, in which a laminate according to the invention is shown. The laminate comprises at least one layer including a resistance element (1) and at least one layer formed of a fibre reinforced thermoplastic mat (2). The resistance element (1) and the fibre reinforced thermoplastic (2) are laminated under pressure, preferably by vaccuum moulding, and the thermoplastic is melted under heat and then cooled so that the resistance element completely or partly is enclosed by thermoplastic and is consolidated as a laminate. The glass fibre reinforced thermoplastic works as an insulator to the mould and for protecting the resistance element. The reinforcing fibre protects resistive wires against mechanical penetration. One example on this effect is that metal devices which scrape against the glass fibre reinforcement will not easily penetrate the thermoplastic layer, so that the resistance element is protected.

A thermoplastic is a relatively poor electric conductor. LDPE (low density polyethylene) has a creep current resistance of about 3 Ω/cm², and correspondingly, for PET it is 2 Ω/cm². Experiments have shown that with PET, a substantially better resistance in the finished product, probably because of reduced occurences of short-circuit-formation between resistive wire loops. Another possible explantation is the large amount of glass fibre in the thermoplastic during the experiments, about 60%.

In one embodiment of the invention, the resistance element (1) and the fibre reinforced thermoplastic layer (2) may be arranged for adhesion to each other during the moulding process. However, the thermoplastic layers enveloping the loop of the heat element (1) will achieve full binding to each other, and thus also bind the laminate very well.

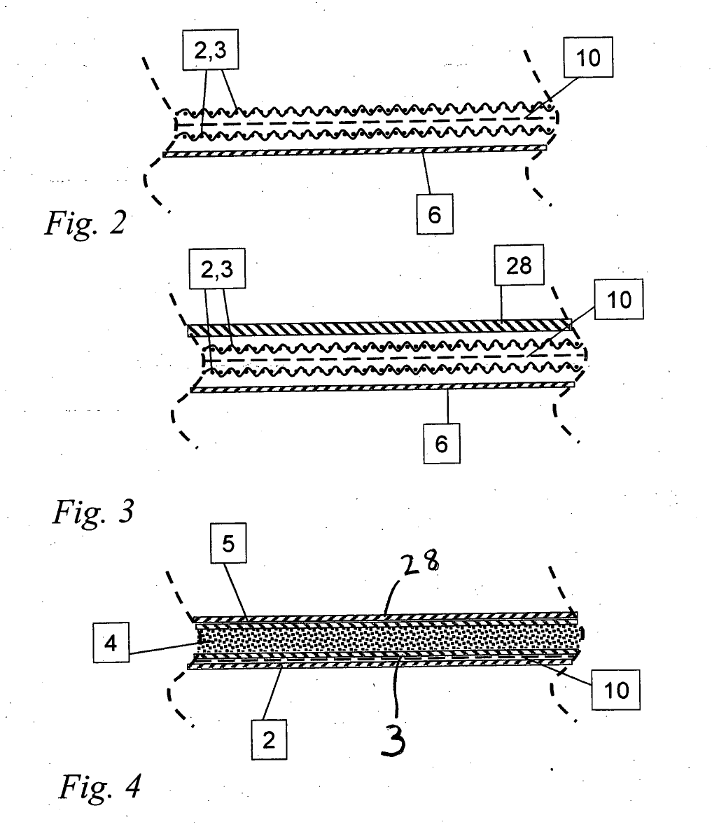

The laminate comprises in a preferred embodiment, as shown in FIG. 2, at least two layers (2,3) of fibre reinforced thermoplastic, in which the resistance element (1) is arranged between the two fibre reinforced plastic layers (2,3). The resistance element may for example be placed in the thermoplastic in order to heating locally so as to weld together two parts, e.g., the inner part of a hull to an outer skin of a hull. The finished product will itself be sturdy and wear-resistant, but for additional strength in the laminate at least one sandwich core (4) and at least one additional fibre reinforced thermoplastic layer (5) may be arranged so as to form a loadbearing or structural element, as shown in FIG. 4. Thus, it is possible to form a construction element sandwich.

The mould comprises in one embodiment of the invention at least one plate (6) which forms a base for the various layers in the laminate during moulding. The material in the plate (6) may for example be metal, a composite comprising carbon fibres, or another material or combination of thermal conductive materials. The first fibre reinforced thermoplastic layer (2), the resistance element (1) and the second fibre reinforced thermoplastic layer (3) may be arranged on the plate (6) during the moulding process. In a possible embodiment of the invention, the mould may for example be a metal plate (6) in which a layer (2) of glass fibre reinforced thermoplastic layer is arranged. Thereafter, the resistance element is arranged, and then an additional layer (3) of glass fibre reinforced thermoplastic. The fibre reinforced thermoplastic (2) will insulate the resistance element thermally against the plate (6). Another effect of the plate (6) is to even the heat distribution in the mould, so as to form a laminate which is as homogeneous as possible.

The mould or the plate (6) may remain a part of the finished product, so that it forms a part of the finished laminate.

The resistance element is arranged for emitting heat energy so that the melting process is supplied with heat from within the laminate. This may take place by direct supply of electric energy to the resistance element (1). In a possible solution resistive wire (10) is provided with two terminals (20, 21) for connection to electricity supply cables (30, 31). The electricity supply cables (30, 31) may be completely or partly enclosed in the laminate. They may also extend outside the laminate.

Another possibility for heating the laminate is inductive heating. The resistance element can be a closed circuit which is exposed to an electromagnetic alternating field, so that a current is induced in the resistance element (1). In such an embodiment of the invention, the resistance element may include at least one elongate resistive wire (10) arranged in a pattern which forms a preferably closed circuit, and in which the resistance element (1) is arranged for external supply of electric energy via induction.

In a preferred embodiment, at least the resistive wire is arranged in a pattern on an area, e.g. as indicated in FIG. 1. Because the thermoplastic layer is resistant to corrosive substances, the resistive wire may be arranged directly onto the thermoplastic layer (2), for example imprinted or etched directly onto the thermoplastic layer (2), which preferably is a partly consolidated thermoplastic textile. In a possible embodiment of the invention the resistance element is present as a silk screen imprinted or photo-engraved resistance element (1) including a resistive wire (10) in an insulating matrix (50), which is very simply sketched in FIG. 1.

At least one temperature sensor (40) may be arranged within the laminate. An example of this is shown in FIG. 1. The temperature sensor (40) may be arranged within the laminate and close to the resistive wire (10), so that the melting process which is provided with heat for the resistance element (1) may be controlled with regard to temperature. At least one temperature sensor (40) may be located within the laminate. The temperature sensor may be used for several purposes, among which is temperature control during manufacturing of the laminate, but also as a temperature sensor which controls the temperature in the finished product and is coupled to a thermostatic switch for the electric supply. It is also possible to include a thermostat for regulating the temperature in the finished product, and an electric fuse may be built in, e.g., a melting fuse which cuts the electric supply in case the temperature reaches such levels that the laminate starts to melt both during moulding and during use.

The fibre reinforcement (26) in the thermoplastic may in principle be of any material which is non-conductive, electrically insulating material. Conductive fibres such as carbon are excluded in this connection. The fibre reinforced thermoplastic mat (2) includes in a preferred embodiment non-conductive reinforcement filaments (26), preferably of glass fibre filaments. The content of glass fibre reinforcement is of less signification, but may be between 10-90%, preferably 30-70%, and most preferably 50-65%.

Manufacture of a Fibre Reinforced Laminated Resistance Element

A fibre reinforced resistance element may be manufactured in the following manner:
arranging at least one resistance element (1) together with at least one layer of a mat (2) of reinforcement fibres (25) and thermoplastic fibres (26) in a mould; and
moulding the resistance element (1) together with the fibre reinforced thermoplastic layer (2) under heat so that the thermoplastic fibres (26) melt and fill the fibre reinforcement (25), and under pressure, preferably by vacuum moulding under a vaccuum bag (28), so that they together form the fibre reinforced laminated resistance element.

In a more specified embodiment of the invention, the energy for the moulding process may completely or partly be supplied by means of the resistance element itself to be moulded into the laminate.

The resistance element (1) may for example be formed by etching of a metal film onto a layer including thermoplastic. The thermoplastic layer is in a preferred embodiment preferably glass fibre reinforced.

The mould may in one embodiment comprise at least one form or plate (6) which forms a base for the various layers in the laminate when moulding. The plate (6) is integrated into the laminate during the moulding process so as to form a part of the laminate.

The moulding process is a clean process utilizing dry starting materials, so as to reduce the danger for fluid loss and contamination in the environment or in the finished product to a substantial degree.

Examples of Use of a Fibre Reinforced Laminated Resistance Element According to the Invention

Wear-resistant and sturdy heat elements may advantageously be utilized as heat source or construction element for stretchers and beds. The laminate may aslo constitute a structural part for mounting in buildings, for example on walls, floors, ceilings or other suitable places. The heat element may according to the invention also be a part of a structural element, which may constitute a structural part of a wall, or a loadbearing or structural fibre reinforced part of anything, floors, the inner side of car doors, bathroom floors, both as a base for tiles or as independent, loadbearing floor, as a bath tub having incorporated heating cables, or as a panel heater which can be mounted (glued) directly on a wall. Some advantages with such a laminate are that it may be manufactured so as to have a large area, and that the heat element may be made so as to have a very low thickness in relation to its area, while having a large resistance to bending moment and be wear-resistant.

In the case of using PET, a further advantage of the laminate according to the invention is that the product is hygienic because PET is approved for use together with food articles. The finished laminate according to the invention may itself constitute the heat supply for preparation of food or for heating cabinets. The laminate may also be used for cooking vessels, so that no stove is needed, but only an electric outlet. The cooking vessel may even sterilize itself by heating to a suitable temperature and period. PET is approved for cooking because it does not emit harmful substances (soda bottles are made of PET).

1. A laminate, comprising:
at least one layer comprising a resistance element; and
a first layer formed of a fiber reinforced thermoplastic mat;
wherein said resistance element and said fiber reinforced thermoplastic mat form a lamination without any additional layer therebetween so that the resistance element is completely or partly enclosed by thermoplastic and consolidated as a laminate.

2. The laminate according to claim 1, wherein said resistance element and said fiber reinforced thermoplastic layer adhere directly to each other.

3. The laminate according to claim 1, wherein the laminate comprises a second layer of fiber reinforced thermoplastic, said resistance element being arranged between said first and second fiber reinforced thermoplastic layers.

4. The laminate according to claim 3, wherein said laminate further comprises at least one sandwich core and a third fiber reinforced thermoplastic layer.

5. The laminate according to claim 1, wherein there is at least one plate which forms a base for the various layers in the laminate during a molding process.

6. The laminate according to claim 5, wherein the material in the plate is metal, a carbon composite or material or combination of materials which are thermally conductive.

7. The laminate according to claim 5, wherein the first fiber reinforced thermoplastic layer, the resistance element and the second fiber reinforced thermoplastic layer are arranged on the plate during the molding process.

8. The laminate according to claim 5, wherein the plate forms a part of the finished laminate.

9. The laminate according to claim 1, wherein the resistance element is arranged for emitting heat energy during a melting process.

10. The laminate according to claim 1, wherein the resistance element comprises at least one elongate resistive wire and wherein said at least one resistive wire is provided with two terminals for connection to electric supply cables.

11. The laminate according to claim 10, wherein said at least one resistive wire is arranged in a pattern.

12. The laminate according to claim 10, wherein said at least one resistive wire has been imprinted or etched directly onto the first thermoplastic layer.

13. The laminate according to claim 10, wherein the electric supply cables extend outside the laminate.

14. The laminate according to claim 1, wherein at least one temperature sensor is arranged within the laminate.

15. The laminate according to claim 14, wherein the temperature sensor is arranged within the laminate and close to the resistive wire, so that a melting process which is supplied with heat from the resistance element may be controlled with regard to the temperature.

16. The laminate according to claim 1, in which the resistance element is a silk screen imprinted or photo-engraved resistance element comprising a resistive wire in an insulating matrix.

17. The laminate according to claim 1, wherein the first fiber reinforced thermoplastic mat includes non-conductive reinforcement filaments.

18. The laminate according to claim 9, wherein said resistance element comprises at least one elongate resistive wire arranged in a pattern which forms a preferably closed electric circuit, and in which the resistance element is arranged for external supply of electric energy via induction.

19. A method for manufacturing a fibre reinforced laminated resistance element, comprising the following steps:
arranging at least one resistance element together with at least layer of a mat of reinforcement fibres and thermoplastic fibres in a mould;
moulding the resistance element together with the fibre reinforced thermoplastic layer under heat so that the thermoplastic fibres melt and fill the fibre reinforcement, and under pressure, preferably by vacuum moulding, so that they together form the fibre reinforced laminated resistance element.

20. The method according to claim 19, which further comprises the following step:
supplying energy to the moulding process completely or partly by means of the resistance element itself which is to be moulded into the laminate.

21. The method according to claim 19, wherein the resistance element is formed by etching of a metal film onto a layer comprising thermoplastic.

22. The method according to claim 19, wherein the resistance element is formed by etching of a metal film onto a glass fibre reinforced layer of thermoplastic.

23. The method according to claim 19, wherein the mould comprises at least one plate which forms a base for the various layers in the laminate by moulding.

24. The method according to claim 23, wherein the plate is integrated in the laminate during the moulding process so as to form a part of the laminate.

25. A laminate produced by the method of claim 19.
